(19) United States
(12) Patent Application Publication
(10) Pub. No.: US 2020/0217389 A1
(43) Pub. Date: Jul. 9, 2020

(54) HYDRAULIC DEVICE

(71) Applicant: KYB CORPORATION, Tokyo (JP)

(72) Inventors: Yoshiyuki OGAWA, Tokyo (JP); Kousuke SATOU, Tokyo (JP); Fumiaki OONO, Tokyo (JP); Ryohei ARAI, Tokyo (JP)

(73) Assignee: KYB CORPORATION, Tokyo (JP)

(21) Appl. No.: 16/649,001

(22) PCT Filed: Aug. 14, 2018
(86) PCT No.: PCT/JP2018/030276

§ 371 Date: Mar. 19, 2020

(30) Foreign Application Priority Data
Jan. 31, 2018 (JP) 2018-014667

(51) Int. Cl. F16F 9/32; F15B 15/14

(52) U.S. Cl. CPC F16F 9/32; F15B 15/149; F15B 2211/7051; F15B 15/1428; F15B 15/1433; F15B 15/1447

(57) ABSTRACT

A hydraulic device of the present invention includes an outer tube, a bottom portion that closes one end of the outer tube, an inner tube inserted into the outer tube, a movable portion movable relatively to the outer tube and the inner tube in an axial direction, coupling members attached to the outer periphery of the inner tube, and fixing tools that are in contact with the coupling members and fix the inner tube to the bottom portion.

### TECHNICAL FIELD

The present invention relates to a hydraulic device.

### BACKGROUND ART

Some hydraulic devices such as shock absorbers and linearly moving outer tubes adopt a structure in which an inner tube is provided inside an outer tube. In such a hydraulic device, for example, as disclosed in JPH08200315A, a bolt penetrating the bottom of a bottomed cylindrical outer tube may be used to fix an inner tube to the bottom of the outer tube (for example, see Patent Literature 1).

### SUMMARY OF INVENTION

By the way, a bracket for attaching the hydraulic device may be provided at the bottom of the outer tube. In the method of fixing an inner tube as described above, since the bolt penetrates the axial center of the bottom of the outer tube, and the bracket also needs to be provided on the axis of the bottom, the bolt and the bracket must be arranged shifted in the axial direction.

Therefore, in the hydraulic device adopting the method of fixing an inner tube as described above, there is a problem that the overall length and the weight are increased.

Therefore, an object of the present invention is to provide a hydraulic device that can reduce the overall length and is lightweight.

In order to achieve the above object, a hydraulic device of the present invention includes an outer tube, a bottom portion that closes one end of the outer tube, an inner tube inserted into the outer tube, a movable portion movable relatively to the outer tube and the inner tube in an axial direction, a coupling member attached to an outer periphery of the inner tube, and a fixing tool that is in contact with the coupling member and fixes the inner tube to the bottom portion.

### BRIEF DESCRIPTION OF DRAWINGS

FIG. 1 is a longitudinal sectional view of an actuator according to one embodiment.

FIG. 2 is a sectional view of a bottom side portion of the actuator according to one embodiment.

FIG. 3 is a left side view of the actuator according to one embodiment.

FIG. 4 is an X-X sectional view of the actuator according to one embodiment.

FIG. 5 is a longitudinal sectional view of a part of an actuator according to a first modification of one embodiment.

### DESCRIPTION OF EMBODIMENTS

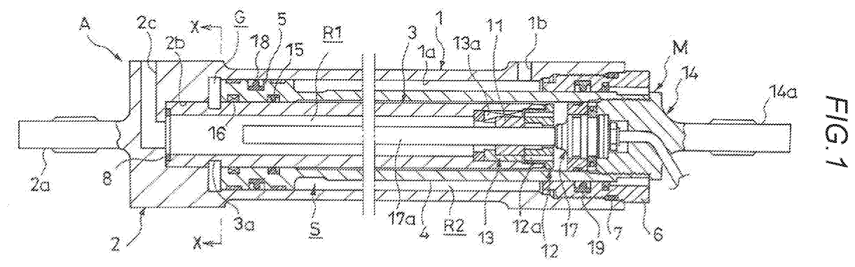

Hereinafter, the present invention will be described based on embodiments illustrated in the drawings. A hydraulic device in one embodiment is embodied by being applied to an actuator A. The actuator A as the hydraulic device includes, as illustrated in FIG. 1, an outer tube 1, a bottom portion 2 that closes one end of the outer tube 1, a cylindrical inner tube 3 inserted into the outer tube 1 and coupled to the bottom portion 2 to form an annular gap S between the inner tube 3 and the outer tube 1, a cylindrical piston rod 4 having one end thereof closed and in slide contact with the outer periphery of the inner tube 3, and a piston 5 provided to the piston rod 4 and in slide contact with the inner periphery of the outer tube 1.

Hereinafter, each part of the actuator A as the hydraulic device will be described in detail. The outer tube 1 in the present embodiment is a cylindrical body including an aluminum alloy, and one end thereof, which is the left end in FIG. 1, is closed by the bottom portion 2, as illustrated in FIG. 1. In the present embodiment, the outer tube 1 and the bottom portion 2 are integrally formed of the aluminum alloy, but may be formed as separate components. Furthermore, a hard anodic oxide film 1a is formed on the inner periphery of the outer tube 1 to improve slidability and wear resistance. The aluminum alloy that is a base material of the outer tube 1 and the bottom portion 2 is an alloy containing copper, manganese, silicon, magnesium, zinc, nickel, and the like in aluminum, and is superior in strength and the like to pure aluminum. Using the aluminum alloy for the outer tube 1 can contribute to weight reduction of the actuator A as the hydraulic device, but the base material of the outer tube 1 is not limited to the aluminum alloy.

In addition, an annular rod guide 6 that is in slide contact with the outer periphery of the piston rod 4 and guides an axial movement of the piston rod 4 relative to the outer tube 1 is provided on the inner periphery of an opening at the other end of the outer tube 1, which is the right end in FIG. 1. Note that the outer tube 1 includes a pressure inlet 1b that communicates the inside of the outer tube 1 to the outside of the outer tube 1 at a position near the right end in FIG. 1 and not interfering with the rod guide 6.

The rod guide 6 is screwed to the inner periphery of the outer tube 1 in the right end of FIG. 1, and an annular seal member 7 is interposed between the outer tube 1 and the rod guide 6. The seal member 7 seals a space between the outer tube 1 and the rod guide 6. Furthermore, the rod guide 6 includes an annular seal member 19 on the inner periphery of the rod guide 6. The seal member 19 is in slide contact with the outer periphery of the piston rod 4 to seal a space between the piston rod 4 and the rod guide 6.

In addition, the bottom portion 2 includes an I-shaped bracket 2a that enables the actuator A to be attached to a mounting portion at the left end in FIG. 1, a recessed portion 2b that opens from the right end in FIG. 1 in the axial direction, and a pressure inlet 2c that opens from the side and communicates with the bottom of the recessed portion 2b.

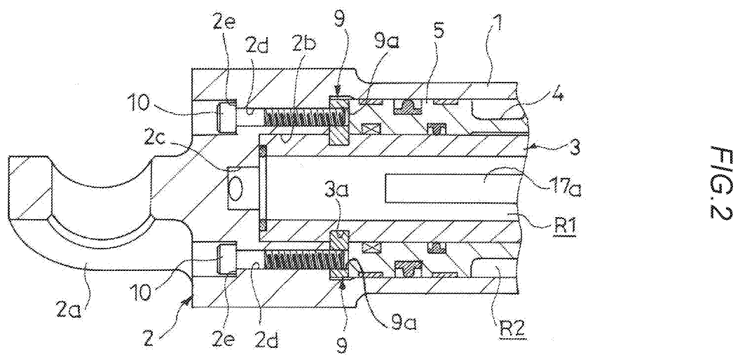

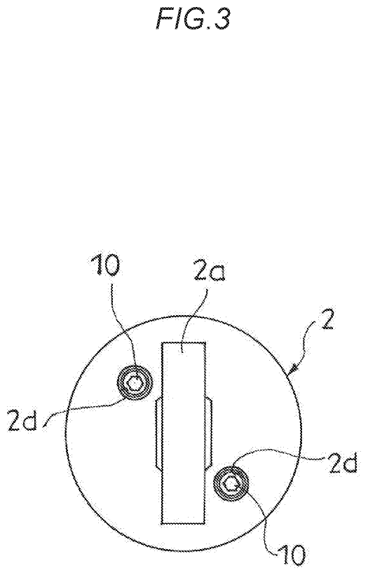

Furthermore, as illustrated in FIGS. 2 and 3, the bottom portion 2 includes two through holes 2d and 2d that open from positions avoiding the bracket 2a, extend in the axial direction of the actuator A, and open at positions avoiding the recessed portion 2b.

The cylindrical inner tube 3 is inserted into the recessed portion 2b of the bottom portion 2. In addition, the annular gap S is formed between the inner tube 3 and the outer tube 1. The outer peripheral side of the recessed portion 2b, which is the left end of the bottom portion 2 in FIG. 1, faces the annular gap S, and the through holes 2d and 2d communicate with the annular gap S.

An annular seal member 8 is arranged between the bottom of the recessed portion 2b of the bottom portion 2 and the inner tube 3, and a space between the bottom portion 2 and the inner tube 3 is sealed by the seal member 8. Note that, since the pressure inlet 2c opens at the bottom of the recessed portion 2b, the pressure inlet 2c is not closed by the inner tube 3 and the seal member 8.

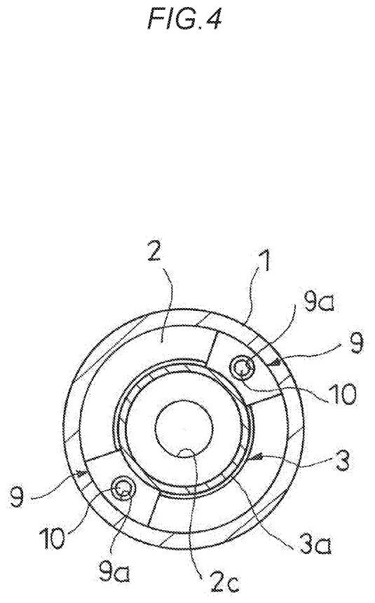

The outer periphery of the inner tube 3 near the left end in FIG. 1 is provided with an annular groove 3a formed over the entire periphery. As illustrated in FIGS. 2 and 4, fan-shaped coupling members 9 and 9 are fitted in the groove 3a. A screw hole 9a is provided in each of the coupling members 9 and 9. Note that the groove 3a does not have to be annular, and may be provided only at positions where the coupling members 9 and 9 of the inner tube 3 are fitted. The through holes 2d and 2d have smaller diameters on the outer tube 1 side from intermediate points, and include stepped portions 2e and 2e in the intermediate points. When bolts 10 and 10 as fixing portions are inserted into the through holes 2d and 2d and screwed into the screw holes 9a and 9a, the heads of the bolts 10 and 10 abut against the stepped portions 2e and 2e. The inner tube 3 is then pulled into the recessed portion 2b of the bottom portion 2 via the coupling members 9 and 9, and the inner tube 3 is fixed to the bottom portion 2. Furthermore, since axial positions of the coupling members 9 and 9 can be adjusted by a rotation operation of the bolts 10 and 10, it is possible to control a load applied to the seal member 8 sandwiched between the inner tube 3 and the bottom of the bottom portion 2. Note that the coupling members 9 and 9 may be in contact with the bottom portion 2 with the inner tube 3 fixed to the bottom portion 2.

An annular head cap 12 is screwed to the inner periphery of the inner tube 3 at the right end in FIG. 1, and a permanent magnet 11 is attached to the inner periphery of the inner tube 3 at the right end in FIG. 1. The head cap 12 is provided with a passage 12a, and a holder 13 that holds the permanent magnet 11 and is mounted on the inner periphery of the inner tube 3 is also provided with a passage 13a. Therefore, the inside of the inner tube 3 communicates with the outside of the inner tube 3 via the passages 12a and 13a.

The piston rod 4 is cylindrical and has a cap 14 mounted at one end of the piston rod 4, which is the right end in FIG. 1. The cap 14 includes an I-shaped bracket 14a that enables the actuator A to be attached to a mounting portion. Therefore, one end of the piston rod 4, which is the right end in FIG. 1, is closed by the cap 14. Furthermore, the piston rod 4 is in slide contact with the outer periphery of the inner tube 3 and can move in the axial direction relative to the outer tube 1 and the inner tube 3. The piston rod 4 includes, on the inner periphery thereof at the left end in FIG. 1, annular seal members 15 and 16 in slide contact with the outer periphery of the inner tube 3. Therefore, the inside of the piston rod 4 and the inner tube 3 forms a space that is expanded and contracted by a relative movement between the piston rod 4 and the inner tube 3 in the axial direction, and this space forms an extension side chamber R1. That is, the piston rod 4 defines the extension side chamber R1 together with the inner tube 3. The extension side chamber R1 communicates with the pressure inlet 2c, and it is possible to supply a liquid to the extension side chamber R1 and to discharge the liquid from the extension side chamber R1 via the pressure inlet 2c.

The cap 14 holds a stroke sensor 17 including a sensor rod 17a that accommodates a magnetostrictive wire for detecting an axial position of the permanent magnet 11. The sensor rod 17a is inserted into the inner tube 3 through the inner periphery of the head cap 12 and the inner periphery of the permanent magnet 11. Then, the stroke sensor 17 applies a current pulse to the magnetostrictive wire in order to generate a magnetic field on the outer periphery of the magnetostrictive wire. The stroke sensor 17 then outputs a signal corresponding to a time until a vibration pulse generated, due to the Wiedemann effect, in a portion of the magnetostrictive wire facing the permanent magnet 11 returns. As a result, it is possible to detect, from the signal output by the stroke sensor 17, an axial displacement of the piston rod 4 relative to the inner tube 3. Note that, in the present embodiment, the stroke sensor 17 is mounted to control extension and contraction of the actuator A by feeding back the displacement detected by the stroke sensor 17, but the stroke sensor 17 may be eliminated, if unnecessary.

The annular piston 5 in slide contact with the inner periphery of the outer tube 1 is provided on the outer periphery of the piston rod 4 at the left end in FIG. 1. An annular seal member 18 in slide contact with the inner periphery of the outer tube 1 is provided on the outer periphery of the piston 5, and a space between the piston 5 and the outer tube 1 is sealed by the seal member 18.

The piston 5 divides the annular gap S between the outer tube 1 and the inner tube 3 into a space between the outer tube 1 and the piston rod 4 and a space between the outer tube 1 and the inner tube 3 and facing the bottom portion 2. Furthermore, a pressure side chamber R2 is formed in the space between the outer tube 1 and the piston rod 4, and an air chamber G is formed in the space between the outer tube 1 and the inner tube 3 and facing the bottom portion 2. As described above, the piston 5 partitions the annular gap S into the pressure side chamber R2 between the outer tube 1 and the piston rod 4, and the air chamber G. The pressure side chamber R2 communicates with the pressure inlet 1b provided on the outer tube 1, and it is possible to supply a liquid to the pressure side chamber R2 and to discharge the liquid from the pressure side chamber R2 via the pressure inlet 1b.

Furthermore, the through holes 2d and 2d communicate with the air chamber G as illustrated in FIG. 1. The bolts 10 and 10 are inserted into the through holes 2d and 2d as described above, but no seal is provided between the bolts 10 and 10 and the wall surfaces of the through holes 2d and 2d. Therefore, the atmosphere is allowed to be supplied to and discharged from the air chamber G through the through holes 2d and 2d. That is, the air chamber G is released to the atmosphere through the through holes 2d and 2d.

As described above, in the present embodiment, the piston rod 4, the piston 5, and the cap 14 move relatively to the outer tube 1 and the inner tube 3 in the axial direction, and the piston rod 4, the piston 5, and the cap 14 constitute a movable portion M.

Furthermore, a pressure receiving area that receives the pressure of the pressure side chamber R2 in a direction in which the piston rod 4 is pushed leftward in FIG. 1 relative to the outer tube 1 is an area obtained by subtracting an area of a circle whose diameter is the outer diameter of the piston rod 4 from an area of a circle whose diameter is the inner diameter of the outer tube 1. A pressure receiving area that receives the pressure of the extension side chamber R1 in a direction in which the piston rod 4 is pushed rightward in FIG. 1 relative to the outer tube 1 is an area of a circle whose diameter is the outer diameter of the inner tube 3. In the present embodiment, the pressure receiving area that receives the pressure of the extension side chamber R1 is made equal to the pressure receiving area that receives the pressure of the pressure side chamber R2.

When the actuator A configured as described above supplies a liquid such as hydraulic oil to the extension side chamber R1 and discharges the liquid from the pressure side chamber R2, the liquid supplied to the extension side chamber R1 pushes the movable portion M and causes the movable portion M to be retracted from the inside of the outer tube 1, so that the actuator A makes an extension operation. Conversely, when the actuator A supplies a liquid such as hydraulic oil to the pressure side chamber R2 and discharges the liquid from the extension side chamber R1, the liquid supplied to the pressure side chamber R2 pushes the movable portion M and causes the piston rod 4 to be inserted into the outer tube 1, so that the actuator A makes a contraction operation.

Furthermore, in the actuator A configured as described above, a pressure receiving area acting in a direction in which the pressure of the extension side chamber R1 pushes the movable portion M rightward in FIG. 1 relative to the outer tube 1 is equal to a pressure receiving area of the movable portion M that receives the pressure inside the pressure side chamber R2. Therefore, if the pressure of the extension side chamber R1 when the actuator A makes the extension operation is the same as the pressure of the pressure side chamber R2 when the actuator A makes the contraction operation, the actuator A exerts thrust that is the same in magnitude and different only in direction between the extension operation and the contraction operation. That is, the actuator A functions as a double rod type linearly moving outer tube. Furthermore, since the air chamber G is released to the atmosphere by the through holes 2d and 2d and inside of the air chamber G is always kept at the atmospheric pressure, the space does not function as an air spring. Thus, the extension and contraction operation of the actuator A is not hindered, and the actuator A can extend and contract smoothly.

As described above, the actuator (hydraulic device) A of the present invention includes the outer tube 1, the bottom portion 2 that closes one end of the outer tube 1, the inner tube 3 inserted into the outer tube 1, the movable portion M that can move relatively to the outer tube 1 and the inner tube 3 in the axial direction, the coupling members 9 and 9 attached to the outer periphery of the inner tube 3, and the bolt (fixing portion) 10 that is in contact with the coupling members 9 and 9 and fixes the inner tube 3 to the bottom portion 2.

In the actuator (hydraulic device) A configured as described above, the bolts (fixing tools) 10 and 10 do not have to be arranged on the axial center of the bottom portion 2 because the inner tube 3 is fixed to the bottom portion 2 by use of the coupling members 9 and 9 and the bolts (fixing tools) 10 and 10, which are attached to the outer periphery of the inner tube 3. Therefore, it is possible to prevent the overall length from being longer by providing the bracket 2a to the bottom portion 2, which accordingly reduces the overall weight. Therefore, according to the hydraulic device of the present invention, it is possible to reduce the overall length and the weight.

Note that the fixing tools are not limited to the bolts 10 and 10 but may be rivets as long as the coupling members 9 and 9 can be pulled toward the bottom portion 2 and the inner tube 3 can be fixed to the bottom portion 2. Therefore, for example, each of the fixing tools may include a hook that hooks on one of the coupling members 9 and 9 at one end or a push clip at a tip, and a screw portion that can screw a nut at the other end. In this case, the axial positions of the coupling members 9 and 9 can be adjusted by adjusting positions of the nuts. As described above, the fixing tools only need to be in contact with the coupling members 9 and 9 and fix the inner tube 3 to the bottom portion 2. Furthermore, the shapes of the coupling members 9 and 9 can be appropriately changed in design so as to be suitable for the structure of the fixing tools, and the coupling members 9 and 9 may be integrated with the inner tube 3.

Note that, in the case of the present embodiment, since the groove 3a is provided in the inner tube 3 and the coupling members 9 and 9 are fitted, welding for integrating the coupling members 9 and 9 with the inner tube 3 and correcting welding distortion are not necessary. Therefore, a processing cost can be reduced.

Furthermore, in the actuator (hydraulic device) A of the present embodiment, the bottom portion 2 includes the bracket 2a and the through holes 2d and 2d that open from the positions avoiding the bracket 2a to communicate the inside and the outside of the outer tube 1, and the fixing tools are the bolts 10 and 10 inserted into the through holes 2d and 2d and screwed to the coupling members 9 and 9. According to the hydraulic device configured as described above, since the through holes 2d and 2d open at the positions avoiding the bracket 2a, it is easy to operate the bolts 10 and 10, and it is also possible to properly fix the inner tube 3 to the bottom portion 2 by controlling a tightening torque of the bolts 10 and 10.

Furthermore, in the actuator (hydraulic device) A of the present embodiment, the inner tube 3 forms the annular gap S between the inner tube 3 and the outer tube 1, the movable portion M includes the piston rod 4 that is cylindrical, has one end thereof closed, and is in slide contact with the outer periphery of the inner tube 3 to define the extension side chamber R1 together with the inner tube 3 and the piston 5 that is provided to the piston rod 4 and in slide contact with the inner periphery of the outer tube 1 to partition the annular gap S into the air chamber and the pressure side chamber R2 between the outer tube 1 and the piston rod 4, the coupling members 9 and 9 are arranged in the air chamber G, and the through holes 2d and 2d communicate with the air chamber G. Therefore, according to the actuator (hydraulic device) A, since the air chamber G is released to the atmosphere, the actuator (hydraulic device) A can smoothly make the extension and contraction operation, and a seal for sealing the through holes 2d and 2d is not necessary.

Furthermore, in the case of the present embodiment, the seal member 8 sandwiched between the inner tube 3 and the bottom portion 2 is provided, and the through holes 2d and 2d are provided along the axial direction of the outer tube 1 relative to the bottom portion 2. According to the hydraulic device configured as described above, the load of pressing the inner tube 3 against the bottom portion 2 can be adjusted according to the degree of insertion of the bolts 10 and 10 into the screw holes 9a and 9a of the coupling members 9 and 9, and thus the load applied to the seal member 8 sandwiched between the inner tube 3 and the bottom of the bottom portion 2 can be controlled. Therefore, since the load applied to the seal member 8 can be optimized, a space between the inner tube 3 and the bottom portion 2 can be tightly sealed without damaging the seal member 8.

Furthermore, the through holes 2d and 2d are formed along the axial direction of the outer tube 1 from the position avoiding the bracket 2a of the bottom portion 2 as described above, but may be through holes oblique to the axis of the outer tube 1. In this case, the screw holes 9a and 9a provided in the coupling members 9 and 9 also only need to open so as to coincide with the opening directions of the through holes 2d and 2d.

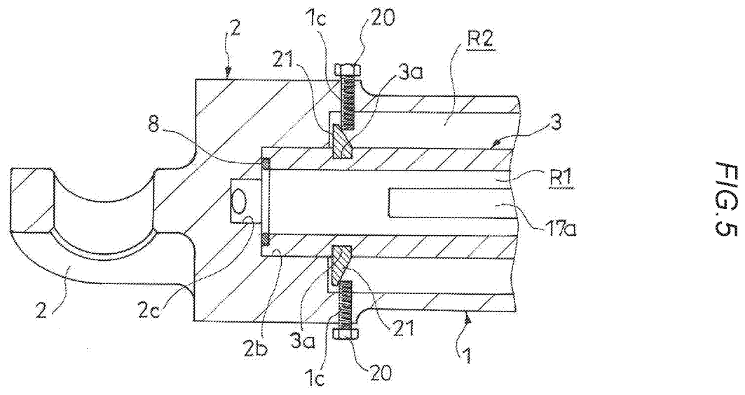

Furthermore, as in a first modified example illustrated in FIG. 5, the inner tube 3 may be fixed to the bottom portion 2 by providing holes 1c opening from the side of the outer tube 1, attaching screws 20 and 20 as the fixing tools to the holes 1c, and bringing the screws 20 and 20 into contact with coupling members 21 and 21. In this case, if the side surfaces of the coupling members 21 and 21 opposite to the bottom portion are formed as inclined surfaces inclined toward the bottom portion 2 as the side surfaces are separated from the inner tube 3 without being provided with screw holes, the coupling members 21 and 21 are drawn closer to the bottom portion 2 as tips of the screws 20 and 20 advance toward the inner tube 3. Therefore, the load applied to the seal member 8 can be controlled by the degree of insertion of the screws 20 and 20 into the outer tube 1.

In the above description, the hydraulic device has been described as the actuator A. However, the present invention can be applied to any hydraulic device having a structure in which the inner tube 3 inserted into the outer tube 1 is fixed to the bottom portion 2 that closes an end of the outer tube 1. Therefore, the hydraulic device can be applied not only to the actuator A but also to a shock absorber. In addition, the application of the hydraulic device is not limited, and the hydraulic device can also be widely used for vehicles, aircraft, buildings, and other machines.

Although the preferred embodiments of the present invention have been described above in detail, modifications, variations and changes are possible without departing from the scope of the claims.

The present application claims priority based on Patent Application No. 2018-014667 filed on Jan. 31, 2018 to the Japanese Patent Office, and the entire contents of this application are incorporated herein by reference.

1. A hydraulic device comprising:
an outer tube;
a bottom portion that closes one end of the outer tube;
an inner tube inserted into the outer tube;
a movable portion movable relatively to the outer tube and the inner tube in an axial direction;
a coupling member attached to an outer periphery of the inner tube; and
a fixing tool that is in contact with the coupling member and fixes the inner tube to the bottom portion.

2. The hydraulic device according to claim 1, wherein
the coupling member is fitted into a groove provided on the outer periphery of the inner tube.

3. The hydraulic device according to claim 1, wherein
the bottom portion includes a bracket and a through hole that opens from a position avoiding the bracket and communicates an inside and an outside of the outer tube, and
the fixing tool is a bolt inserted into the through hole and screwed to the coupling member.

4. The hydraulic device according to claim 3, wherein
the inner tube forms an annular gap between the inner tube and the outer tube,
the movable portion includes a piston rod that is cylindrical, has one end of the piston rod closed, and is in slide contact with the outer periphery of the inner tube to define an extension side chamber together with the inner tube, and
a piston provided on the piston rod and in slide contact with the inner periphery of the outer tube to partition the annular gap into an air chamber and a pressure side chamber between the outer tube and the piston rod,
the coupling member is arranged in the air chamber, and
the through hole communicates with the air chamber.

5. The hydraulic device according to claim 3, comprising
a seal member sandwiched between the inner tube and the bottom portion, wherein
the through hole is provided along an axial direction of the outer tube relative to the bottom portion.
